(19) United States
(12) Patent Application Publication
(10) Pub. No.: US 2009/0095602 A1
(43) Pub. Date: Apr. 16, 2009

(54) Electric Hand Control, Especially for Electrically Adjustable Hospital and Care Beds

(75) Inventors: Svend Erik Knudsen Jensen, Sonderborg (DK); Jesper Rorby Jensen, Sonderborg (DK); Verner Smidt, Broager (DK); Bjame Carstensen, Augustenborg (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Linak A/S

(21) Appl. No.: 12/084,786

(22) PCT Filed: Nov. 10, 2006
(86) PCT No.: PCT/DK2006/000622

§ 371 Date: May 9, 2008

(30) Foreign Application Priority Data
Nov. 11, 2005 (DK) PA2005 01569

(51) Int. Cl. H01H 27/06

(52) U.S. Cl. 200/42.02

(57) ABSTRACT

An electric hand control, especially for electrically adjustable hospital and care beds comprising a number of activation switches (3;3a,3b), and a number of locking switches (9, 10;11;13, 14), which can be activated by means of a locking element (7) by which means the circuit for the activation switches (3;3a,3b) is cut off, so that the function belonging to it becomes inactive or locked. In an embodiment the locking switches are on-/off switches and in another embodiment the locking switches are based on a read switch and a magnet and in yet another embodiment the locking switches are based on a wave shaped disc (9) mounted over two contact points (10).

The present invention relates to an electric hand control especially for electrically adjustable hospital and care beds as stated in the preamble of claim 1.

As examples of adjustable hospital beds EP 0 488 552 A1 Huntleigh Technology plc and U.S. Pat. No. 4,425,673 B-W Health Products, Inc. can be mentioned. Typically, there are two controls for the bed, a hand control with which the patient can adjust the bed to the wanted position and a control panel at the end of the bed where the hospital staff can make adjustments of the bed, among these, adjustment in excess of the adjustments possibilities of the patient. At the same time the staff can block medical positions that are not allowed for the patient in question, so that the patient cannot inadvertently activate a position not allowed. For instance raising the leg section by a thigh bone fracture.

In stead of a separate hand control and control panel it can be desirable with only the hand control. For care beds which typically are not as technically advanced as hospital beds and which are only equipped with a hand control it can also be expedient with a blocking of certain adjustment functions.

In CH 681 833 Magnetic Elektromotoren AG a hand control for hospital beds with a blocking arrangement for various functions is mentioned. The control is a pneumatic control, and the keys are placed in pairs with one key for activation of the function and the other for reversing to the initial position. The blocking arrangement works strictly mechanical with a pin with two wings placed between two sets of contacts. By turning the pin with a key for that purpose the two wings can be brought under a flange on the keys and block the pressing of the keys. In an electric hand control from the same company described in CH 691 638 Magnetic Elektromotoren AG the keys are blocked completely electronically. For this purpose the hand control contains two read-switches, which can be activated with a key comprising two magnets, one for each of the two read-switches. When the read-switch is activated the control goes into programming mood, where the control can be programmed into locking and unlocking the operation keys.

The invention concerns hand controls, where small square brick shaped switches with a pushbutton on the top side can be used, said switches are called “Tactile Switches” or “Tact Switches”. The switches are placed under a springy tongue in the top side of the hand control, on which a foil with graphics localizing the key and its function is mounted. By pressing the foil the tongue is pressed inwards and affects the pushbutton on the switch. The migration on the pushbutton is very modest, that is in the same size as the tolerance on the subjects, which makes a mechanical locking difficult. This is also reflected in the known technology mentioned above, where a mechanical solution is chosen for the pneumatic hand control and an electrical solution for the electric hand control.

The object of the invention is to provide an electric hand control with electric locking of the keys.

According to claim 1 the hand control is characterized in that it comprises a number of locking switches, which can be activated by means of the locking element, by what means the circuit for the activation switches is cut off. By cutting off the circuit for the activation switches, these are made inactive and can therefore not set off a function even though they are operated. By traditionally placing the keys in pairs it is possible to cut off the circuit for both keys with only one locking switch, and the locking element can also be mounted between the two keys, so that the layout of the hand control compared to known hand controls can be preserved.

In an embodiment locking switches with an axially moveable operation element are used, and the locking element is rotatable about its axis and has a knob, which activates the locking switch when the locking element is turned. Such a locking switch has the advantage, that it is actively forced to a power cut and problems with a sticking switch are thereby avoided.

In another embodiment the locking switches are read-switches. The locking element is also here rotatable about its axis and comprises a magnet which activates the read-switch for cutting off the circuit for the activation switch when the locking element is turned. Unlike the construction in CH 691 638 no programming is needed the circuit for the activation switch can simply be cut off.

In yet another embodiment the locking switches have a wave shaped disc mounted over two contact points in the circuit for the activation switch and which cut off the circuit for this purpose when the locking element is turned. In a position the wave shaped disc rests on the two contact points with a wave top and in another position the wave disc straddles over the two contact points with a wave through and the circuit for the activation switch is thereby cut off.

Characteristic for all the embodiments is that they cannot be broken as a result of over rotation, as the locking element can be turned freely. In the locking position where the activation switch is locked, the locking element is meshing with a latch mechanism.

To indicate whether the keys are locked or unlocked the locking element can be equipped with an indicator, which when displaced is brought to a window, visible on the front of the hand control. In a simple way it can be a red marking, which is brought to the window, so that it becomes visible in the locking position through a transparent field in the cover foil.

Further features of the invention will be explained more fully below in connection with an embodiment of the invention with reference to the accompanying drawing. In the drawing:

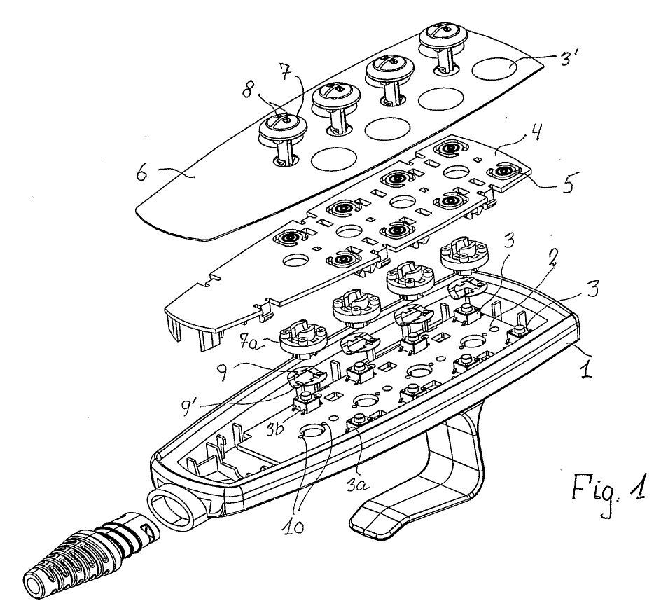

FIG. 1 shows an exploded view of a first embodiment of the hand control according to the invention,

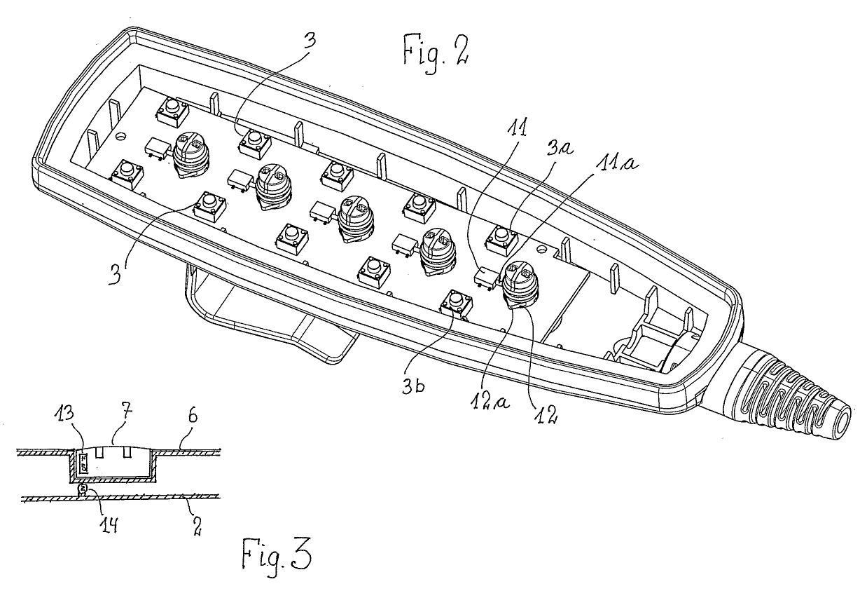

FIG. 2 shows the housing of the hand control with printed circuit in another embodiment of the hand control according to then invention, and

FIG. 3 shows a cross section through a turning knob in a third embodiment of the hand control according to the invention.

The embodiment deals with a hand control for electrically adjustable care and hospital beds with actuators for raising and lowering an back rest and leg rest and also raising and lowering the bed as a whole. For this purpose the hand control is equipped with keys placed in pairs, where one key brings about the raising and the other one the lowering.

The hand control comprises a cup shaped housing 1 of plastic, wherein a printed circuit 2 with two rows of activation switches 3 in the form of tactile switches is mounted, and above is a plate 4 with tongue like keys 5. The topside of the housing is equipped with a cover foil 6 with graphics 3′ localizing the keys and their function. The hand control has a locking function for the activation switches 3, where the locking is done with knobs 7 which are rotatable about their axis. The turning can be done with a special key with two knots, which can be brought into mesh with the two holes 8 on the top side of the keys.

In a first embodiment the locking switch, which operates a few keys, is based on an electric conductive wave shaped ring 9 mounted on a lower part 7a of the turning knob 7. The tops 9′ on the wave shaped ring 9 can be brought into contact with a couple of contact points 10 on the printed circuit 2 by turning the knob 7 which causes the circuit for the two adjacent activation switches 3a,3b to be closed and said adjacent activation switches are then operational. By turning the knob 7 the wave tops 9′ can be brought out of contact with the contact points 10 so that the wave shaped ring 9 straddle over the contact points with the wave through. The circuit for the activation switches 3a, 3b are then cut off and said activation switches are inactive. The function in the bed controlled by it is thereby locked, i.e. it cannot be activated before the knob is turned again so that the circuit for the activation switches 3a, 3b is once more closed. Whether the keys or more precisely the activation switches are locked or workable appears from an indication on the top side of the knob 7. In the lower part of the knob 7a there can be a latch mechanism, so that a perceptible click can be felt when the key is in the active position or for that matter in the locked position, but in this position the key will anyhow feel loose as the wave shaped ring is free from its contact points.

Here is shown a locking function for all the keys, but it is understood that a locking function for selected keys is possible, for instance so that only the back rest and the foot rest in a bed can be locked whereas the keys for raising and lowering the bed cannot be locked.

In FIG. 2 of the drawing another embodiment for the invention is shown, where the locking function is based on a locking switch in the form of a on/off switch 11, which when activated is brought to cut off the circuit for the two adjacent activation switches 3a, 3b. Here the lower part of turning knob 7 has two opposite knots 12, whit a small notch 12a in the outer end as a latch mechanism. By turning the knob 7 the wing is brought in abutment with the activation element 11a of the locking switches and presses it inwards until it rests in the notch 12a in the outer end of the knot. When the on/off switch 12 is activated the circuit for the activation switches 3a, 3b and the related function in the bed become inactive.

In FIG. 3 of the drawing another solution is mentioned, where the locking switch is based on a magnet 13 embedded in the turning knob 7 and a read-switch 14 mounted on a printed circuit 2. By turning the knob 7 so that the magnet is brought in a position above the read-switch said read-switch for cutting off the circuit for the activation keys 3a, 3b is activated. When the magnet 13 is turned away from the read-switch, said read-switch falls back and the circuit for the activation switches is reestablished.

Characteristic for all three embodiments is that the knob 7 cannot be over rotated in a mechanical end stop and break as a result. The knob can be turned all the way around and assume the two positions of locked and unlocked.

1. Electric hand control comprising a number of electric activation switches (3;3a,3b) placed in pairs in a control circuit, a number of related locking elements (7), which from a parking position can be brought to a locking position where the locking element blocks at least one activation switch, wherein the hand control comprises a number of locking switches (9,10; 11; 13,14), which can be activated by means of the locking element (7), by which means the circuit for the activation switches (3;3a,3b) is cut off.

2. Hand control according to claim 1, wherein the locking switches have an axially movable operation element (11 a) and that the locking element (7) is rotatable about its axis and has a knob (12), which when the locking element is turned, activates the locking switch for cutting off the circuit for the activation switch.

3. Hand control according to claim 1, wherein the locking switches are read-switches (14) and the locking element is rotatable about its axis and comprises a magnet (13), which activates the read-switch for cutting off the circuit for the activation switch when the locking element is turned.

4. Hand control according to claim 3, wherein the locking switches have a wave shaped disc (9) mounted over two contact points (10) in the circuit for the activation switch and which cuts off the circuit for this purpose when the locking element is turned.
